(19) United States
(12) Patent Application Publication
(10) Pub. No.: US 2015/0167302 A1
(43) Pub. Date: Jun. 18, 2015

(54) FIBRE-REINFORCED MINERAL BUILDING MATERIAL

(71) Applicant: Karlsruhe Institute of Technology (KIT), Karlsruhe (DE)

(72) Inventors: Lothar Stempniewski, Ettlingen-Oberweier (DE); Moritz Urban, Albersweiler (DE)

(73) Assignee: Karlsruhe Institute of Technology (KIT), Karlsruhe (DE)

(21) Appl. No.: 14/413,210

(22) PCT Filed: Jul. 3, 2013
(86) PCT No.: PCT/EP2013/001961

§ 371 Date: Jan. 6, 2015

(30) Foreign Application Priority Data
Jul. 6, 2012 (DE) 10 2012 106 083.5

(51) Int. Cl. E04C 5/07; E04B 1/98; B32B 37/24

(52) U.S. Cl. CPC E04C 5/07; B32B 37/24; E04B 1/98; E04C 5/073; B32B 2037/243; B32B 2419/00

(57) ABSTRACT

A fiber-reinforced mineral building material includes at least one fiber, which is embedded into the mineral building material, at least one ductile or elastic coating on the fiber, and particles that are material-bonded with the coating. The dimensions of the particles on the greater share of the surface area exceed the thickness of the coating and the particles in part project material-bonded into the mineral building material.

### BACKGROUND OF THE INVENTION

The invention relates to a mineral building material reinforced with a long fiber, in accordance with the first patent claim.

Mineral building materials contain, for example, cement, lime, gypsum or clay as essential component and were generally modified with aggregates, for example gravel for concrete, or sand for mortar mixes or plaster. However, they can also be composed of natural, geological components, such as clay.

Mineral building materials are distinguished by a high compressive strength, only a moderate tensile strength, along with a pronounced brittleness. A high tensile strength and plasticity of hardened, mineral building materials are critical in structures which are subjected to uneven and intermittent load stresses, for example caused by earth movements such as earth slides or earthquakes. The goal therefore is to reinforce masonry and mineral building materials, in particular concrete components, mortar layers and clay in such a way that a tensile stress can be absorbed.

For concrete components, it is generally known that the tensile strength and the fracture toughness can be increased with the aid of reinforcing steel.

Natural and synthetic plaster systems are furthermore known in various cultures which are advantageously reinforced with natural fiber materials that are worked into the plaster.

Mineral building materials with artificial reinforcement systems are known in principle.

Various reinforcement concepts are available for the product selection, which comprise the following reinforcing elements based on fibers. E [electric] glass fibers, AR [alkaline resistant] glass fibers, aramid fibers, carbon fibers, basalt fibers, natural fibers and synthetic fibers, in particular, are suitable products.

Individual fibers having a typical diameter ranging from 5 to 27 μm are processed further into fiber products, either bundled with torsion (yarns) or without torsion (rovings). Nonwovens, mats, meshes, scrim, laminates, woven materials or knitted fabrics are produced with these yarns or rovings.

Nonwovens are light-weight creations, weighing approximately 20-50 g/m², which are not woven and consist of glass fibers or thermoplastic fibers and are more suitable for preventing fine tears or for reinforcing fine layers.

Mats are extremely high-strength structures, weighting approximately 100-1,500 g/m², and are used in particular as geo-textiles. They are very stiff and thus are not easy to work with. The problem is similar for laminates.

Fabrics consist of warp and weft threads which cross each other and offer a bi-directional reinforcement option. Owing to the wavy course of the threads, the mechanical properties are negatively influenced. To minimize this effect, non-twisted, wide rovings can be used which minimize the waviness and the bending radius. A substantially thinner, more easily deformed fabric is thus obtained as a side effect. This type of structure furthermore favors the impregnation option since penetration is easier as compared to the round cross section for the same cross-sectional area, wherein this is a disadvantage for rougher matrix material.

Knitted fabrics or scrim are the products offering the highest variation complexity and flexibility in the design. By placing different fiber materials one above the other, oriented differently, it is possible to produce so-called hybrid multi-directional fabrics. As a result, the strength of the textile fabrics can be specified for nearly all directions. The fiber intersection can be secured through impregnation or with fine yarns and are therefore extremely mobile and easy to process.

DE 10 2008 026 615 A1, for example, discloses a hybrid textile reinforcement for brickwork. For this, the reinforcement advantageously consists of bundled, highly extensible fiber strands which are oriented in two directions and are inserted in the form of a mat into a mineral-bonded material.

DE 699 29 540 T2 discloses a similar system for which the fibers are optionally coated, however, to improve the concrete bonding strength and improve the resistance to being pulled out.

Systems are also known from WO 95/34724 for which a plaster layer is additionally connected with the aid of tie rods functioning as dowels to the brickwork underneath.

All of the aforementioned reinforcement systems have in common that they comprise a reinforcement with or without coating, embedded in a matrix of cement material. As a result, not only is the system tensile strength increased for the structural component, but also the safety with respect to parts of the matrix breaking off. In addition, the reinforcement not only protects the surface layers of plaster, but also support the brickwork underneath, in particular during earth movements, by bridging cracks that develop as a result of continuous, flat area binding, thereby stabilizing the brickwork.

### SUMMARY OF THE INVENTION

Starting therefrom, it is the object of the invention to propose a fiber-reinforced, mineral building material which is distinguished by a further increased load capacity and ductility and which has a higher energy-absorption capacity during delamination, in particular when used as reinforcement that is incorporated into a matrix of plaster or another building material. The object furthermore is to propose a method for producing this fiber-reinforced mineral building material, as well as a use for the aforementioned areas of application.

This object is solved with a fiber-reinforced mineral building material having the features as disclosed in claim 1. Advantageous embodiments are disclosed in the dependent claims which refer back to the main claim.

To improve the composite of fibers in a matrix and to achieve an energy-destroying ductility for a load-induced dissolution of the material composite between matrix and fiber through delamination effects, a modification of the fiber surface is proposed. The fibers used are basically the aforementioned fibers and fiber products, such a yarns, rovings, non-woven materials, mats, mesh fabrics, scrim, laminates, woven fabrics, knitted fabrics or textiles. The fibers themselves preferably are glass fibers, carbon fibers, fibers of aramid, basalt, polymer or metal.

This object is solved with a fiber-reinforced mineral building material for which at least one fiber or a fiber bundle, preferably at least two intersecting fibers or fiber bundles and even more preferred a two- or three-dimensional braided fabric, woven fabric or textile fabric of the aforementioned fibers is embedded as matrix into the mineral building material. The mineral building material advantageously is a plaster, applied either in the form of a single plaster layer or in a plaster layer system with several individual layers onto a carrier material (substrate), in particular the brickwork of a building, preferably the exterior wall of a house or any wall (use of the mineral building material as plaster). All or a portion of the fibers are encased either completely or partially with a ductile or elastic, preferably thermoplastic, coating. Advantageously suitable for use as coating materials are resins or synthetic materials (polymers) which harden thermally and/or chemically, preferably adhesives, thermoplastic materials, biopolymers or epoxy resins, wherein the use of vinyl ester resins, diallyl phthalate resins, methyl-methacrylate resins, phenol-formaldehyde resins, amino resins or polyurethane resins is also advantageous. The coatings range in thickness from 3 μm to 5 mm, wherein 50 μm to 400 μm are preferred to maintain the ductility of the fibers. The fiber flexibility is decisive, in particular for the processing and production of the end products, such as goods sold in rolls.

The areas where two fibers intersect are advantageously encased, wherein the coatings come in contact at the intersections and, in the process, form an advantageous material-to-material bond, thereby achieving improved anchoring effects due to cross fibers.

One embodiment provides for a braided material where the fibers are not coated in at least one spatial direction or are coated only in the intersecting areas while they are coated in another direction, meaning in at least one spatial direction. The braided material in the process interacts differently with the surrounding material, depending on the spatial direction, thus making it possible to counteract a preferred crack-forming direction in the mineral building material and/or the substrate underneath through the reinforcement with a special plastic-elastic property profile. It is thus possible to prevent unfavorable cases of cracks or fissures in the brickwork, plaster, concrete or clay, and to achieve an increase in the load strength and ductility in the appropriate direction.

One essential feature comprises the aforementioned coating of the fibers, with particles incorporated material-bonded therein. The dimensions of the particles on the fibers have particle sizes that preferably exceed the coating thickness, meaning they advantageously project form-fittingly into the mineral building material but do not firmly bond with the mineral building material. In case of axial stress on the fiber in the mineral building material (matrix), the particles have a tendency to tilting movements and thus to cant in the coating and to an intensified interlocking. As a result, the particles are guided on the fibers through the form-fitting connection with the mineral building material and simultaneously also the coating on the fibers. The particles are provided with breaking edges for a better interlocking in the mineral building material. Inorganic particles such as sand-blasting good of metal or inorganic non-metal materials (grains of stone, quartz sand, ceramics, hard materials and the like) are preferably used. A broken particle surface with sharp edges on the one hand improves a positive interlocking with the mineral building material and, the other hand, ensures a better material-to-material bond with the coating. Through selecting the grain size distribution of the particles, e.g. with straining processes, the particle compositions can be adapted to the corresponding fiber product, thus ensuring the best possible and stable interlock between the particles and the surrounding material.

The surfaces of the particle regions that project from the coating and into the mineral building material are either non-coated or wetted by polymer. The particle sizes are a characteristic of the system and range from 0.01 mm to 2 cm, wherein a preferred range is between 0.05 mm and 2 mm is the goal. The sought after and preferred surface roughness of the coated fiber has maximum profile heights (Rz, max) ranging from 0.01 mm to 20 mm, preferably from 0.01 to 5 mm and even more preferred from 0.05 and 5 mm (roughness according to DIN EN ISO 4288 (Volume 1998) and/or average roughness values (Ra) of 0.01 mm to 4 mm, depending on the particle density for measurements according to the profile method, based on VDI/VDE 2602, page 2.

If the particle sizes do not exceed the thickness of the coating, a material-to-material bond with the mineral building material does not occur, but only a change in the mechanical properties of the coating. However, with a plastic deformation of the coating, the particles therein can rub against each other and displace each other, thus also resulting in a change in the coating surface. While this also results in interlocking effects with the matrix, it is primarily based on a mutual interaction of the particles in the coating and thus a different mechanism.

It is not absolutely necessary for the particles to be embedded into the coating over its total extension, but preferably only in selected regions, wherein these advantageously extend over the main surface share of the fiber.

According to one embodiment, the fibers or fiber bundles or a braided fabric are advantageously provided with particles only a uniform distances to each other, whereas the regions in-between remain non-coated or the coating of said regions does not contain particles. The fiber regions provided with particles represent anchoring regions for the fibers while the regions without particles do not have the interlocking provided by the particles and exhibit flexibility in case of cracks forming in the matrix. This flexibility permits a moderate axial movement of the fibers in the matrix, wherein the ductility of the coating and/or the friction of the mineral building material directly on the fiber and/or the coating destroys energy and/or frictional energy in case of an axial displacement of the fiber. Following the blocking of the shear stress of the particle-free region, the movement along the fiber is stopped as a result of the interlocking effect of the particle regions. The particles embedded into the coating can move longitudinally or radially on the fiber, which results in a cushioning effect during the removal of the fibers from the mineral matrix and can thus soften dynamic tensile forces.

The production of the aforementioned fiber-reinforced mineral building materials involves the following method steps: making available at least one fiber of polymer or metal, a liquid or flowable coating material with and/or without particles, applying the coating material and the particles to the fibers, as well as hardening of the coating material on the fibers, wherein the coating material becomes rigid, dries out, or becomes filmy.

According to a preferred embodiment, the coating material and the particles are mixed prior to applying them.

The coating material according to one embodiment comprises a thermoplastic which becomes liquid or flowable when the temperature increases above the melting or softening temperature and then solidifies through cooling, thereby hardening. For the purpose of the invention, liquid or flowable means a maximum viscosity of 110000 mPas (Brookfield Spindle 4/1 RPM 23° C.), measured according to DIN 53019, Sections 1-3. With this polymer system, coatings with pronounced elastic and plastic properties can be realized advantageously, which harden quickly as a result of cooling but can also be removed again thermally.

The coating material of a further embodiment comprises a multi-component polymer system, with a binder and a curing agent, wherein the curing agent is an existing material in the atmosphere (e.g. moisture in the air) or the fiber material. With this polymer system, quickly hardening coatings that exhibit increased wear resistance can advantageously be realized quickly, in particular those exhibiting increased resistance at higher temperatures such as occur with a building fire. Two-component adhesives furthermore have the advantage of incorporating the particles into the coating with a higher material-to-material bond and form-fittingly.

According to yet another embodiment, the coating material comprises a multi-component polymer system with a solvent as binder and curing agent, wherein the coating hardens when the solvent component escapes (e.g. lacquers, adhesives). A shrinking process occurs simultaneously which favors an additional bond between the fiber and the coating around the fiber.

The coating material is advantageously applied by impregnating (submerging) the fibers into the liquid or flowable coating material or—in particular in the case of a selective coating of the fiber regions—through external application or spraying onto the fibers. Where applicable, the fibers should be primed.

Impregnation has the advantage of the material penetrating deep into a fiber bundle, so that all fibers are glued together and are joined in a ductile or elastic manner.

Coatings on the outside, on the other hand, only glue together the outside filaments and do not activate the complete fiber bundle in case of stress. Outside positioned fibers are thus initially subjected to higher load stresses while the inside fibers of a bundle are subjected to load stresses only after failure. As a result, a serial stress occurs and, if applicable, a serial failure of the fibers in a fiber bundle.

Different types of coatings are plastic-encased fiber compound materials. These can advantageously be produced as semi-finished fiber products, prepregs or molding compound products which can also be processed further into one of the aforementioned fiber products (fiber bundles, woven material) after first applying a coating.

The fibers can be provided with the particles either through applying (blowing in, sprinkling on or dusting) them onto the not-yet hardened coating or by embedding the freshly coated fibers into a bulk particle good. For embodiments where the surfaces of the particles which project from the coating are coated with the coating material, the particles are preferably mixed into the liquid or flowable coating material and are then applied together with the coating with the aid of one of the aforementioned method steps.

Within the framework of the invention, the fibers do not need to be coated separately or individually and provided with particles, but the aforementioned fiber products such as yarns, rovings, non-woven materials, mats, braided materials, scrim, laminates, woven fabrics or knitted fabrics can be coated either completely or in some sections, following their production to finished or semi-finished fiber products, and to provide them on the whole or in some sections with particles (e.g. in points, stripes, or crosswise in a specific orientation). On flat fiber products, the particles are provided on both sides or only on one side, wherein the application of particles to one side only advantageously simplifies or saves production steps for producing especially flat fiber products. In this way, it is also possible to transfer the shear stresses in specific directions.

Areas of application, meaning uses, for the fiber-reinforced mineral building material in particular are:

mortar (reinforcement for mortar)

plaster (reinforcement for plaster; fiber plaster)

concrete (fiber concrete; mineral fiber panels)

clay (geotextiles, reinforcements for pies construction).

### BRIEF DESCRIPTION OF THE DRAWINGS

The fiber-reinforced mineral building material and the method for producing said material are explained in the following with the aid of exemplary embodiments, as well as Figures. Shown are in:

FIG. 1 A perspective schematic diagram of an individual fiber with coating and therein embedded particles.

FIGS. 2a to c Three embodiments of a single fiber, shown in a sectional view, as well as

FIGS. 3a to c Diagrams of attempts to pull individual fibers out of a matrix composed of lime and cement plaster.

### DETAILED DESCRIPTION

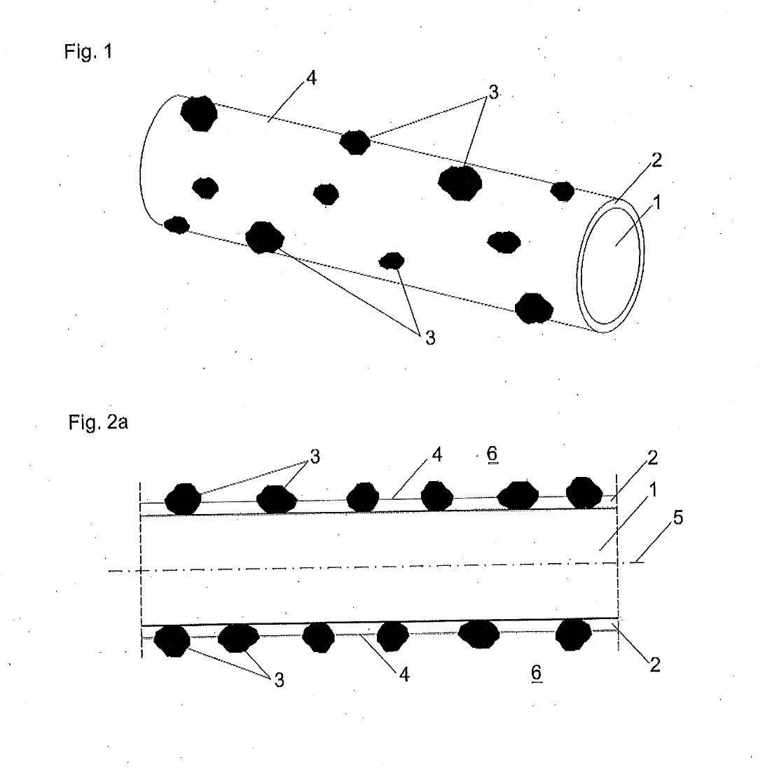

Central elements of the fiber-reinforced mineral building material are the fibers embedded therein. All or a portion of these fibers—as shown with the example of a fiber 1 in FIG. 1—are provided with a ductile and/or elastic coating 2 into which particles 3 are embedded material-to-material, so as to project through the surface area 4 of the coating.

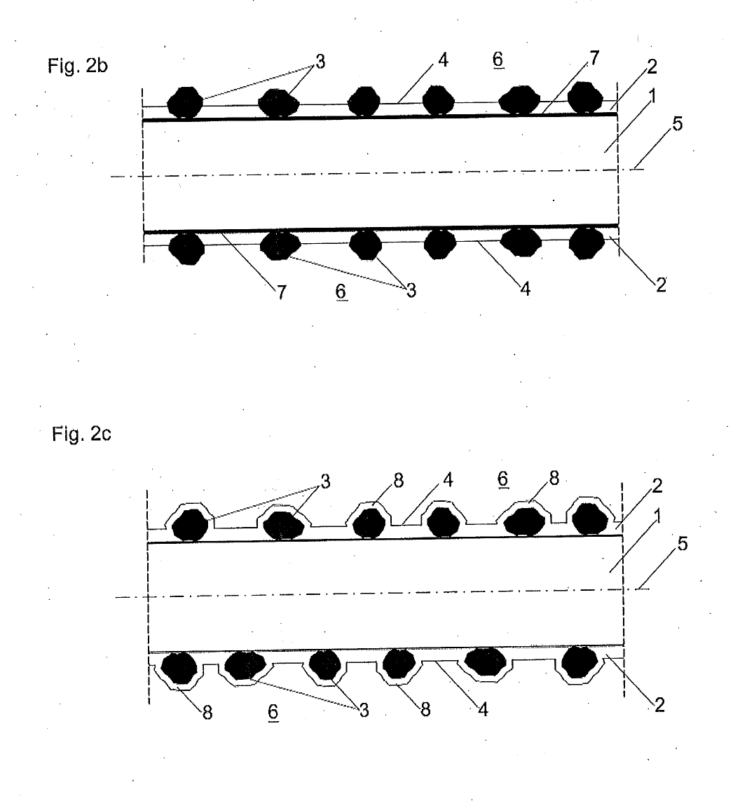

With regard to the coated fiber shown in FIG. 1, a distinction is made between different embodiments, showing examples of three basic designs in FIGS. 2a to c (sectional views along the axis of symmetry 5 of the fiber).

FIG. 2a shows an embodiment where the particles 3 are embedded material-to-material in the coating, completely penetrate the coating, and advantageously but not necessarily come in direct contact with the fiber 1. The coating material is not applied to the particle regions projecting from the surface area 4 of the coating. To advantageously avoid a material-to-material bond of the particles with the surrounding mineral building material 6, the particles are made of an inert material as compared to the surrounding reactive or non-reactive area, or they are wetted with a separating means if the particles are provided with a coating. This type of structural design is distinguished in that the particles rotate moderately during a relative movement between fiber and surrounding mineral building material and that at least some of these fibers are pressed directly into the building material during the rotation. At these indented contact surfaces, a stress singularity is generated in the fiber which is absorbed only by the plastic and/or elastic properties of the fiber. If the fiber is moved further in axial direction, the particles either break out of the mineral building material after a short distance, or depending on how the fibers are embedded in the mineral building material, the particles are released from the coating and thus cause damage to the fiber, or a fiber break occurs. The direct contact between the particles and the mineral building material and fiber favors an immediate, irreversible damage that directly accompanies the axial fiber movement, thus making this embodiment especially suitable for use as a stabilization mechanism to counter the forming of cracks and/or fissures and/or a noticeable branching out of cracks and fissures. However, cracks with a larger width are only bridged to a low degree because of the advanced fiber damage.

FIG. 2b shows an embodiment where the particles 3 are embedded material-to-material in the coating 2 while not penetrating the coating either for the most part or totally, meaning they do not come in contact with the fiber 1. To avoid any direct contact between the particles and non-stressed fiber, one (or more) particle-free, preferably elastic intermediate layer 7 is applied, preferably directly around the fiber. The particle regions projecting from the surface area 4 of the coating are not provided with coating material and are preferably embedded material-bonded into the mineral building material, as previously described with the aid of FIG. 2a. In case of an axial stress on the fiber, the previously described relative movement occurs between the fiber 1 with the intermediate layer 7 and the mineral building material 6. In the process, the particles also tilt in the aforementioned manner, but the coating prevents a direct contact between fiber and particles and thus prevents damage to the fiber which starts directly with an axial movement of the fiber in the mineral building material. As compared to the aforementioned embodiment, larger crack widths are thus possible without damaging the fibers bridging these.

FIG. 2c shows an embodiment where the particles 3 are embedded material-to-material in the coating 2 and are completely incorporated into the coating. Differing from the embodiments shown in FIGS. 2a and b, the particle regions projecting from the coating are also coated with the coating material, so as to form particle caps 8, and are thus advantageously embedded material-to-material into the mineral building material, as described in the above. This embodiment advantageously corresponds to the version shown in FIG. 2a for which an optional, separate particle-free cover layer is provided. The particle caps serve as elastic and/or plastic buffer between the particles and the surrounding mineral building material and avoid direct contact between them. Thus, they prevent a disintegration (mechanical degradation, material fatigue) of the surrounding mineral building material that occurs as direct result of a fiber stress, in particular also prior to a crack forming. In contrast to the fiber material, a mineral building material exhibits brittle material behavior and basically has a pronounced tendency to fatigue. A fiber reinforcement that is modified with particle caps reduces the stress peaks in the region of the material-to-material embedded particles and, in particular, the mechanical properties do not degrade as a result of fatigue with changing stress or only significantly slower. In principle, this embodiment can additionally be combined with at least one intermediate layer according to FIG. 2a which, in addition to a further system elasticity, ensures protection of the fiber against possibly occurring friction between fiber and particles as a result of the aforementioned changing stress.

Softer adhesives such as polyurethane adhesives which bond the particles so as to be easily deformable are above all suitable for the use as reinforcing material in mineral mortars, used as mineral building materials, which should show large deformations at high stress load following the break. The coating material in that case is deformable in such a way that the particles can experience shear stresses of up to 1 mm, relative to the fiber. The fibers can then advantageously be displaced in axial direction in the mineral building material by approximately 0.1 mm to 1 mm, depending on the aforementioned embodiment. With the axial displacement of the fiber, a longer bonding length of the fiber and thus also a higher surface area and anchoring surface for the fiber are activated, thereby distributing the shear stresses and reducing possible shear stress peaks. Owing to the hydration process for the cement and the lime in the mineral building material, the CSHⁱ phases grow into the preferably rough (preferably broken) surface of the particles and thus positively intermesh with the fiber, so as to create the bond. Harder and more high-strength adhesives such as epoxy resins or epoxy resin primers which better hold the grains in the adhesive layer because of tensile strengths of at least 4N/mm² are suitable for high-strength and rigid bonds, e.g. for high-strength types of concrete. As a result, higher forces with more brittle failure were achieved during experiments.

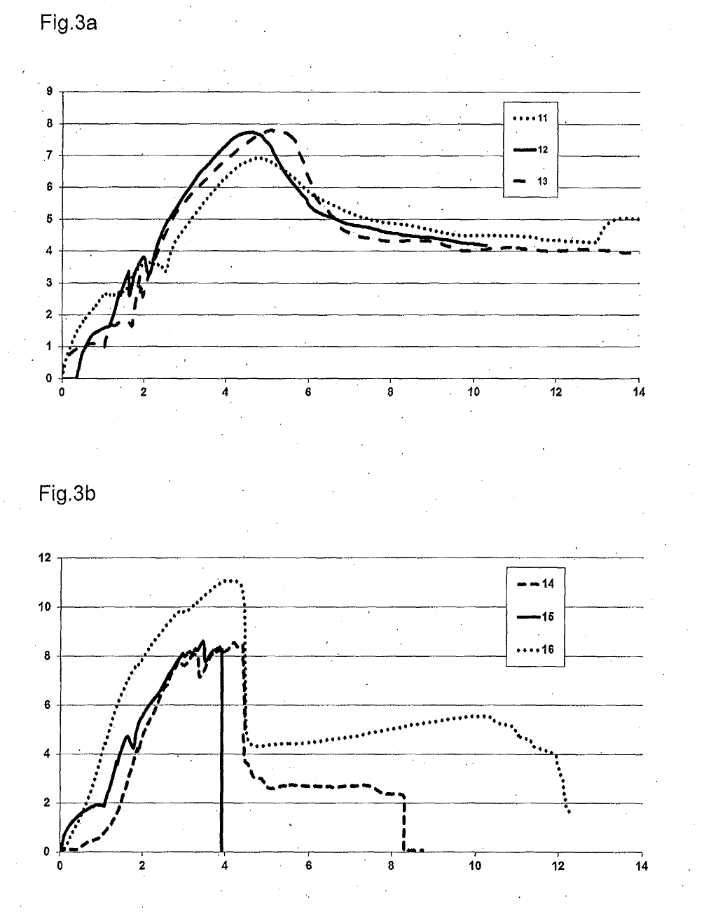

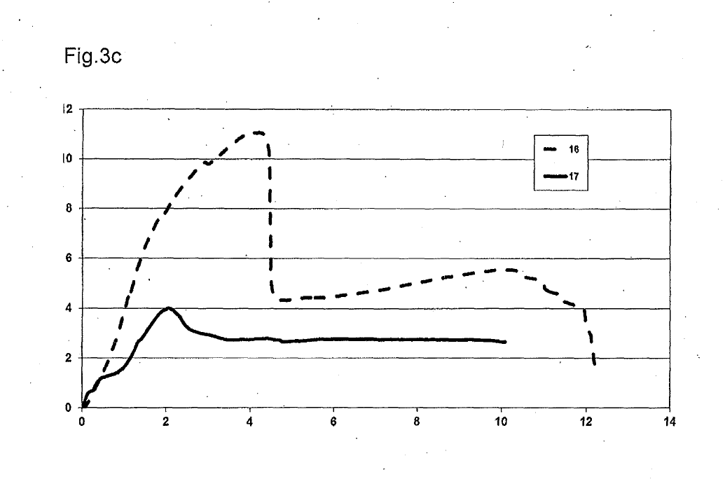

The diagrams in FIGS. 3a to c show the so-called pull-out tensile tests (fiber pull-out tensile tests) for which respectively four individual fibers are pulled from the lime-cement plaster. The tensile force 9 is respectively given in kN, over a traversing distance 10 given in mm. The tensile tests represent an empirical method for finding suitable coating materials for an embodiment according to FIG. 2a, wherein for the example shown a single fiber was selected, provided with two different adhesives as coating material, as well as particles with two grain sizes.

An epoxy resin primer is used for the adhesive (stiff adhesive with a tensile strength of 6N/mm² and an E-modulus of 5000N/mm² tensile stress) and a polyurethane adhesive (soft adhesive with elongation at break exceeding 20%). The particles used were sand-blasting grains with fine quartz sand (density 2.65 kg/m³) and metal particles (density 7.4 kg/m³) which are obtained as waste products with a maximum grain diameter of 1 mm and a rougher quartz sand with a maximum grain diameter of 1 mm. The quartz sand contains a pure mineral quartz share of more than 85%, for which the Mohs hardness is 7 on the scale and which is therefore well suited for the interlocking with mineral building materials. The tensile tests were conducted on a cement-lime mortar as matrix material.

FIG. 3a represents the tensile tests conducted with polyurethane adhesive and both grain sizes (polyurethane adhesive with small grain 11, polyurethane adhesive with large grain 12; polyurethane adhesive with large grain on both sides 13). The soft adhesive is a water-based polyurethane adhesive with a viscosity of 110000 mPas (Brookfield Spindle 4/1 RPM 23° C.), a solid material content of 39%, for a pH value of 8.8). Tensile tests for the soft adhesive showed considerably better reproducible results, with a high deformation capacity independent of the particle size. No large differences showed up using the soft adhesive for applying the particle-containing coating on one side and on both sides.

FIG. 3b shows the same tensile tests, but with epoxy resin primer and both grain sizes (epoxy resin primer with small grain on both sides 14; epoxy resin primer with large grain on one side 15; epoxy resin primer with large grain on both sides 16). For all grain sizes, the stiff adhesive exhibited higher force values than the aforementioned, soft adhesive, but simultaneously also exhibited brittle failure in the mortar matrix surrounding the fiber. Rough grains on both sides lead to significantly higher tensile strength than the small grains and/or having grains on one side only.

FIG. 3c shows a tensile test for comparison between a fiber coated with epoxy resin primer without particles 17 and a fiber coated with epoxy resin primer having large grains on both sides 16 (see also FIG. 2b). When compared to the sample without particle coating, the peak force values achieved as a result of the particles were approximately 2.5 times higher.

1. Fiber-reinforced mineral building material, comprising
a) at least one fiber which is embedded in the mineral building material (6),
b) at least one ductile or elastic coating on the fiber, and
c) particles that are embedded material-bonded into the coating, wherein the dimensions of the particles on most of the surface share of the fiber exceed the thickness of the coating and wherein the particles in part project material-bonded into the mineral building material.

2. Fiber-reinforced mineral building material according to claim 1, characterized in that at least two fibers are provided, which intersect at least once, wherein the coatings come in contact at the intersections.

3. Fiber-reinforced mineral building material according to claim 1, characterized in that a plurality of fibers are provided which orient themselves into at least two spatial directions and form a fabric.

4. Fiber-reinforced mineral building material according to claim 4, characterized in that the fibers are not coated in at least one spatial direction and are coated in at least one spatial direction.

5. Fiber-reinforced mineral building material according to claim 1, characterized in that the coating is composed of one or several polymers, respectively having a layer thickness of 3 μm to 5 mm.

6. Fiber-reinforced mineral building material according to claim 1, characterized in that the coating is composed of an epoxy resin, a vinyl ester resin or a polyurethane.

7. Fiber-reinforced mineral building material according to claim 1, characterized in that the particles comprise quartz sand or sand-blasting good.

8. Fiber-reinforced mineral building material according to claim 1, characterized in that the particles can be composed of different grading curve compositions.

9. Fiber-reinforced mineral building material according to claim 1, characterized in that the particles have breaking edges.

10. Method for producing a fiber-reinforced mineral building material according to claim 1, comprising the following method steps:
a) Making available at least one fiber, a liquid or non-hardened coating material, as well as particles, wherein the dimensions of the particles on most of the surface share of the fiber exceed the thickness of the coating;
b) Applying the coating material and particles to the fibers, wherein the particles are applied simultaneously with, or following the coating material application;
c) Allowing the coating material to harden on the fibers, wherein the coating material solidifies; as well as
c) Embedding of the fibers in the mineral building material, wherein the particles project in part material-bonded into the mineral building material.
